(19) United States
(12) Patent Application Publication
(10) Pub. No.: US 2010/0271563 A1
(43) Pub. Date: Oct. 28, 2010

(54) FILTER AND VIDEO PROJECTOR INCLUDING FILTER

(75) Inventors: Yoshiteru Oda, Hirakata-shi (JP); Yoshiho Suzuki, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/759,301

(22) Filed: Apr. 13, 2010

(30) Foreign Application Priority Data
Apr. 28, 2009 (JP) 2009-110126

(51) Int. Cl. H04N 5/64; B01D 46/00; B01D 50/00

(52) U.S. Cl. 348/789; 55/481; 96/414; 55/385.4; 348/E05.128

(57) ABSTRACT

A slide-type filter for detachably attaching to a housing of an electrical device. The filter includes a filter element. A support frame portion supports the filter element. A finger insert portion extends from the support frame portion and includes an insertion opening into which a finger is insertable. A lid portion is connected to the finger insert portion so as to cover the insertion opening. The lid portion resiliently bends with respect to the finger insert portion to open the insertion opening.

### CROSS-REFERENCE TO RELATED APPLICATIONS

This application is based upon and claims the benefit of priority from prior Japanese Patent Application No. 2009-110126, filed on Apr. 28, 2009, the entire contents of which are incorporated herein by reference.

### BACKGROUND OF THE INVENTION

The present invention relates to a slide-type filter, and a video projector including such a filter.

A projector, or a video projector for projecting and displaying graphical images, generally includes an air inlet. Air is drawn through the air inlet into the projector to cool optical components, which are arranged in the projector. Such a projector includes a filter to prevent dust and dirt from entering the projector through the air inlet (refer to, for example, Japanese Laid-Open Patent Publication No. 2008-170808).

A detachable slide-type filter for use in an electric device is known in the art (refer to, for example, Japanese Laid-Open Patent Publication Nos. 2005-127551 and 2007-143669).

### SUMMARY OF THE INVENTION

In a video projector, to facilitate replacement of the filter, it is preferred that the air inlet and filter not be arranged in a lower surface of the projector but be arranged in, for example, a side surface or rear surface of the projector.

A proposed example of an electrical device including a slide-type filter will now be discussed with reference to FIG. 10. A projector 110 is one example of such an electrical device and electrically processes graphical images. The projector 110 includes a housing 120, which accommodates optical components, and a slide-type filter 140, which is attached to the housing 120.

The housing 120 includes a lower cabinet 121, which has an air inlet 131. The filter 140 is attached to and detached from the lower cabinet 121 of the housing 120.

Specifically, as shown in FIG. 11, a filter insertion receptacle 133, from which the filter 140 is inserted into the lower cabinet 121, is formed in the lower cabinet 121 near the air inlet 131. The filter insertion receptacle 133 is a recess formed in the lower cabinet 121 and extends into the housing 120.

Accordingly, the filter 140 is attached to the lower cabinet 121 by inserting the filter 140 from the filter insertion receptacle 133 into the housing 120 and sliding the filter 140 in the direction of the arrow D1 as viewed in FIG. 11.

As shown in FIG. 12, the filter 140 includes a filter element 150 and a support frame portion 160, which supports the filter element 150. The support frame portion 160 of the filter 140 includes a tab 170, which may be held by one's fingertips. The filter 140 is moved by holding the tab 170 with a person's fingertips. The tab 170 has a small size so as not to affect the aesthetic appeal of the projector 110.

FIGS. 13 and 14 show the filter 140 in a state attached to the lower cabinet 121. FIG. 14 is a cross-sectional view taken along line B-B in FIG. 13.

The filter 140 cannot be easily detached from the housing 120 of the projector 110. Specifically, due to reasons related with the design of the lower cabinet 121, the filter insertion receptacle 133 may be limited to a small size. In such a case, part of the filter insertion receptacle 133 (the part surrounded by broken line S1 in FIG. 14), which is a recess formed in the lower cabinet 121, easily interferes with the filter 140 when moving the filter 140 in the direction of arrow D2. This hinders detachment of the filter 140. Further, since the tab 170 is small so as not to affect the aesthetic appeal of the projector 110, it is difficult to hold the tab 170 with one's fingertips and pull the filter 140, while avoiding interference with part of the lower cabinet 121. In any case, the filter 140 cannot be easily detached.

It is an object of the present invention to provide a filter that may be easily detached from the housing of an electrical device and a video projector including such a filter.

One aspect of the present invention is a slide-type filter for detachably attaching to a housing of an electrical device. The filter includes a filter element. A support frame portion supports the filter element. A finger insert portion extends from the support frame portion and includes an insertion opening into which a finger is insertable. A lid portion is connected to the finger insert portion so as to cover the insertion opening, wherein the lid portion resiliently bends with respect to the finger insert portion to open the insertion opening.

A further aspect of the present invention is a slide-type air filter for detachably attaching to a ventilation hole of a video projector housing. The air filter includes a film-like filter element having a rim. A support frame portion supports at least the rim of the filter element. A finger reception portion is integrally molded with the support frame portion. The finger reception portion includes an inner lid plate portion partitioned by a slit, an outer ring arranged at an outer side of the inner lid plate portion across the slit, and a resilient hinge connecting the inner lid plate portion and the outer ring so that the inner lid plate portion is resiliently movable relative to the outer ring. The inner lid plate portion resiliently pivots to an open position about the resilient hinge when a pressing force is applied to the inner lid plate portion. The pivotal movement of the inner lid plate portion expands the slit and exposes a finger insertion opening. The inner lid plate portion resiliently pivots about the resilient hinge and returns to its original position when the pressing force applied to the inner lid plate portion is released thereby closing the finger insertion opening.

### BRIEF DESCRIPTION OF THE DRAWINGS

FIG. 1 is a perspective view showing a projector according to one embodiment of the present invention;

FIG. 2 is a perspective view showing a housing and filter of the projector of FIG. 1;

FIG. 3 is a perspective view showing the housing and filter as viewed from the inner side of the housing of FIG. 2;

FIGS. 4 and 5 are front perspective views showing the filter;

FIG. 6 is a rear view of FIG. 2;

FIG. 7 is a cross-sectional view taken along line A-A in FIG. 6;

FIG. 8 is a partially exploded perspective view of FIG. 6;

FIGS. 9(a) and 9(b) are perspective views showing the procedures for detaching the filter from the housing;

FIG. 10 is a perspective view of an electrical device including one proposed example of a filter;

FIG. 11 is an enlarged perspective view showing a housing of the electrical device of FIG. 10;

FIG. 12 is a perspective view showing the filter of FIG. 10;

FIG. 13 is a rear view showing the housing of the electrical device of FIG. 11; and

FIG. 14 is a cross-sectional view of the filter and the housing taken along line B-B in FIG. 13.

### DETAILED DESCRIPTION OF THE PREFERRED EMBODIMENTS

A filter for a video projector according to one embodiment of the present invention will now be discussed with reference to the drawings.

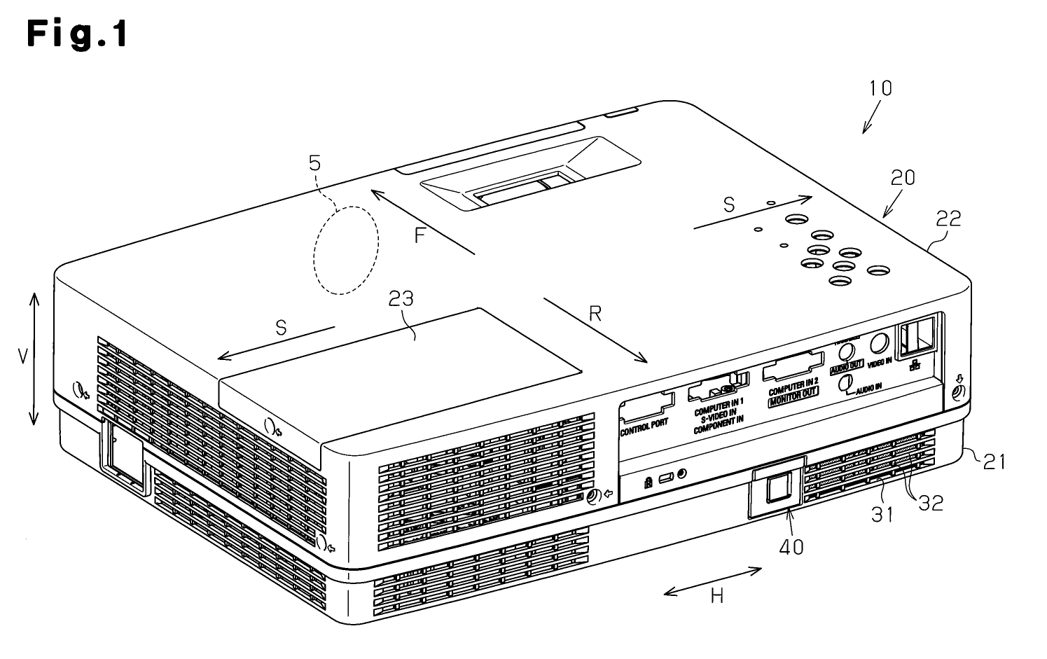

FIG. 1 is a perspective view showing a projector 10, which is a video projector. Except for a projection lens 5, the drawings do not show optical components and electronic components.

In the drawings, the arrows F, R, and S respectively indicate a frontward direction, a rearward direction, and a sideward direction as viewed from a housing 20. The arrow V indicates the vertical direction, and the arrow H indicates the horizontal direction.

As shown in FIG. 1, the projector 10 according to the present embodiment is an electrical device (i.e., electronic device) for electrically processing graphical images and is a front projector that projects light in the frontward direction F out of the housing 20.

The projector 10 includes the housing 20, which accommodates optical components and the like used to project and display graphical images. A filter 40 is attached to the housing 20 of the projector 10 in a detachable manner. The filter 40 is detached by sliding it on the housing 20.

The housing 20 includes a lower cabinet 21, an upper cabinet 22, and a lamp cover 23. The upper cabinet 22 is fastened by screws to the lower cabinet 21. The lamp cover 23 covers a lamp, which is an optical component accommodated in the housing 20. The lamp cover 23 opens and closes the housing 20 so that the lamp may be replaced.

The lower cabinet 21 is part of the housing 20 and includes threaded holes for fastening optical components to the housing 20. Further, the lower cabinet 21 forms an outer shell of the projector 10. The lower cabinet 21 and the upper cabinet 22, which also forms the outer shell of the projector 10, cover the optical components and electronic components.

The lower cabinet 21 and the upper cabinet 22 are formed from synthetic resin. The lower cabinet 21 and the upper cabinet 22 include ventilation holes to cool the optical components in the projector 10.

In the present embodiment, an air inlet 31, which is a ventilation hole, is formed in the lower cabinet 21 facing the rearward direction R. Ambient air is drawn into the projector 10 through the air inlet 31. Accordingly, the air inlet 31 of the lower cabinet 21 opens in the rearward direction R at the rear surface of the projector 10.

The air inlet 31 extends in the horizontal direction H and includes a grid 32, which prevents large foreign matter from entering the projector 10. The grid 32 partitions the air inlet 31 into a plurality of openings. The grid 32 is formed from resin integrally with the lower cabinet 21.

The filter 40 is attached to and detached from the housing 20 near the air inlet 31 of the lower cabinet 21.

Accordingly, the filter 40 is attached to the housing 20 in a detachable manner. In the present embodiment, the filter 40 is attached to and detached from the lower cabinet 21 of the housing 20.

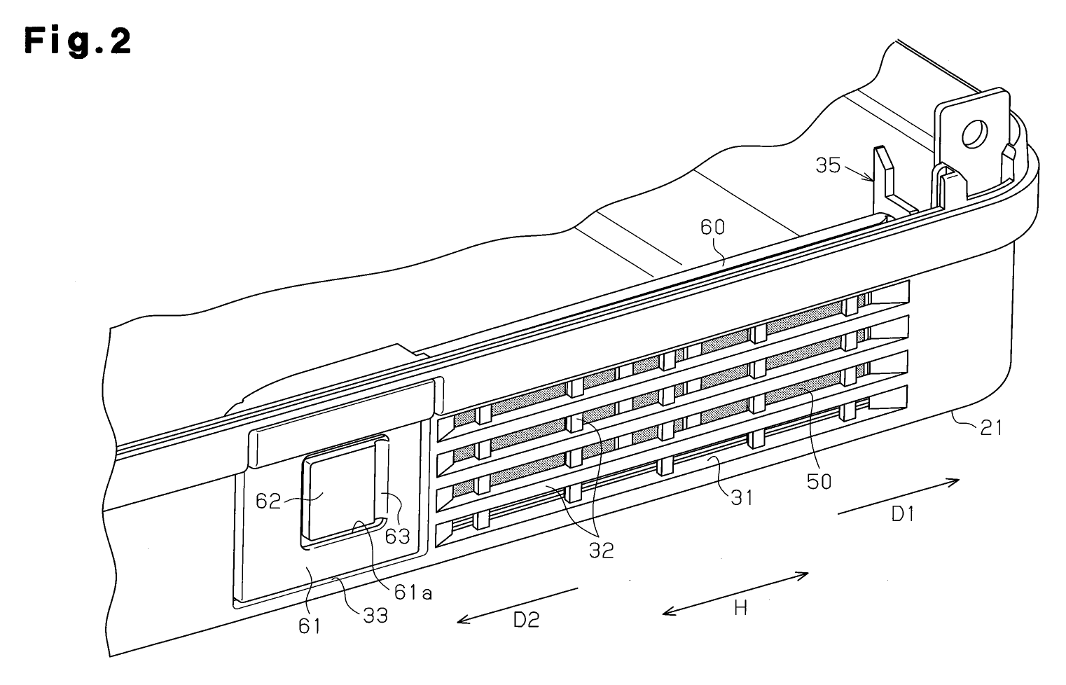

Specifically, as shown in FIG. 2, the lower cabinet 21 includes a tetragonal filter insertion receptacle 33 formed near the air inlet 31. The filter 40 is inserted into the lower cabinet 21, or the interior of the housing 20, from the filter insertion receptacle 33. The filter insertion receptacle 33 is a recess formed in the lower cabinet 21 extending into the housing 20.

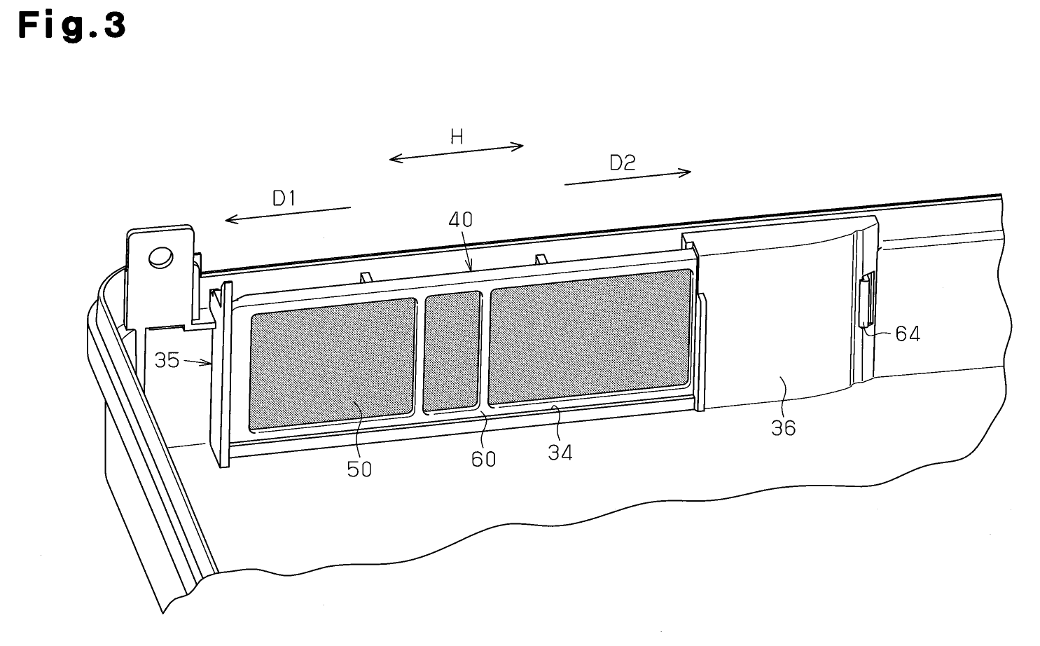

As shown in FIG. 3, the lower cabinet 21 includes a guide groove 34 formed in the housing 20 near the air inlet 31. The guide groove 34 guides the filter 40 when the filter 40 slides in the horizontal direction H.

Accordingly, the filter 40 is inserted into the housing 20 from the filter insertion receptacle 33 and moved in a sliding manner along the guide groove 34. This attaches the filter 40 to the lower cabinet 21.

In FIGS. 2 and 3, the arrow D1 indicates the sliding direction of the filter 40 when attaching the filter 40 to the lower cabinet 21 of the housing 20. Further, the arrow D2 indicates the sliding direction of the filter 40 when detaching the filter 40 from the lower cabinet 21 of the housing 20.

The lower cabinet 21 includes a stopper wall 35 formed in the housing 20 near the air inlet 31. The stopper wall 35 restricts movement of the filter 40 in the direction of the arrow D1. The stopper wall 35 is formed from resin integrally with the lower cabinet 21.

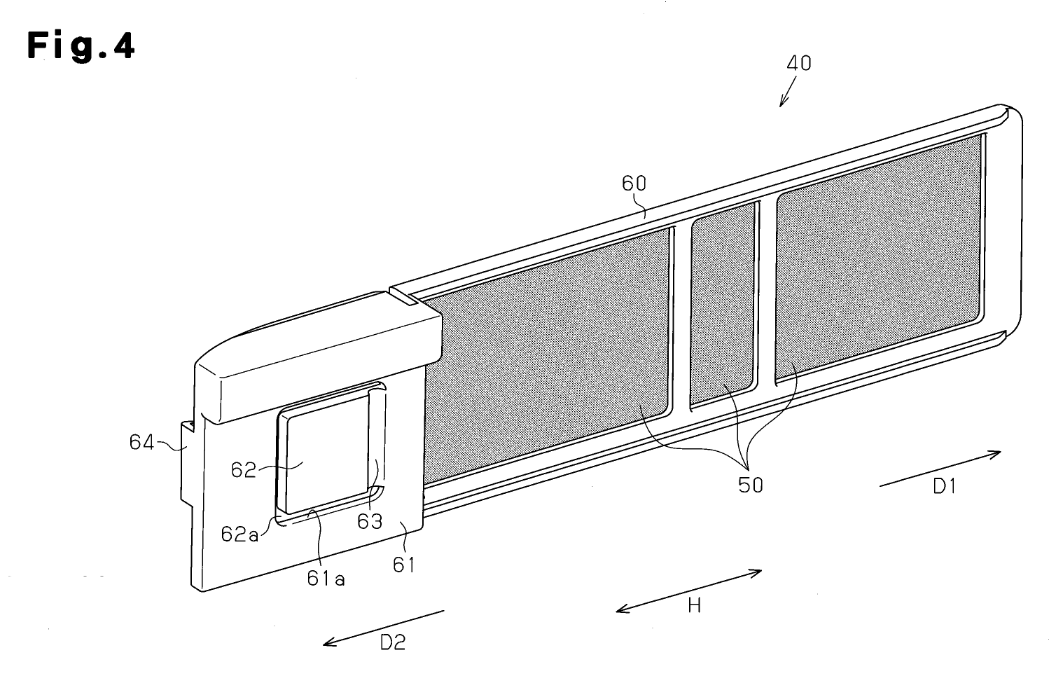

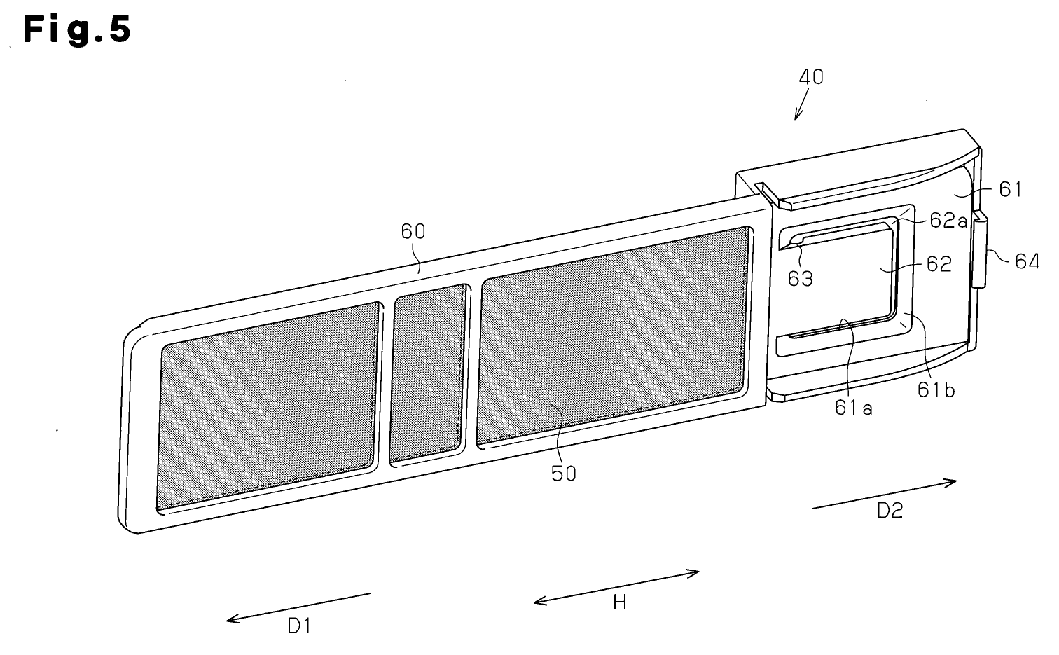

As shown in FIGS. 4 and 5, the filter 40 includes a filter element 50 and a support frame portion 60. The filter element 50 prevents dust and the like from entering the projector 10 through the air inlet 31. The support frame portion 60 is formed from resin and supports the filter element 50. The filter element 50 is, for example, film-like.

The filter element 50, which is tetragonal, may be integrally molded with the support frame portion 60 when molding the support frame portion 60 from a resin. The filter element 50 may be thermally welded to the support frame portion 60 after molding the support frame portion 60 from a resin. The support frame portion 60 has an opening covered by the filter element 50 when the filter element 50 is arranged on the support frame portion 60.

The support frame portion 60, which is tetragonal, is formed from a synthetic resin and includes an opening. Further, the support frame portion 60 is formed to be elastically bendable with the filter element 50 when the filter 40 is attached to and detached from the housing 20.

The support frame portion 60 of the filter 40 is inserted into the housing 20 from the filter insertion receptacle 33 and arranged at a position corresponding to the air inlet 31. At this position, the filter element 50 covers the air inlet 31.

As described above, the filter 40 is a slide-type filter that includes the filter element 50 and the support frame portion 60, which supports the filter element 50. Further, the filter 40 is attached to the housing 20 of the projector 10 in a detachable manner.

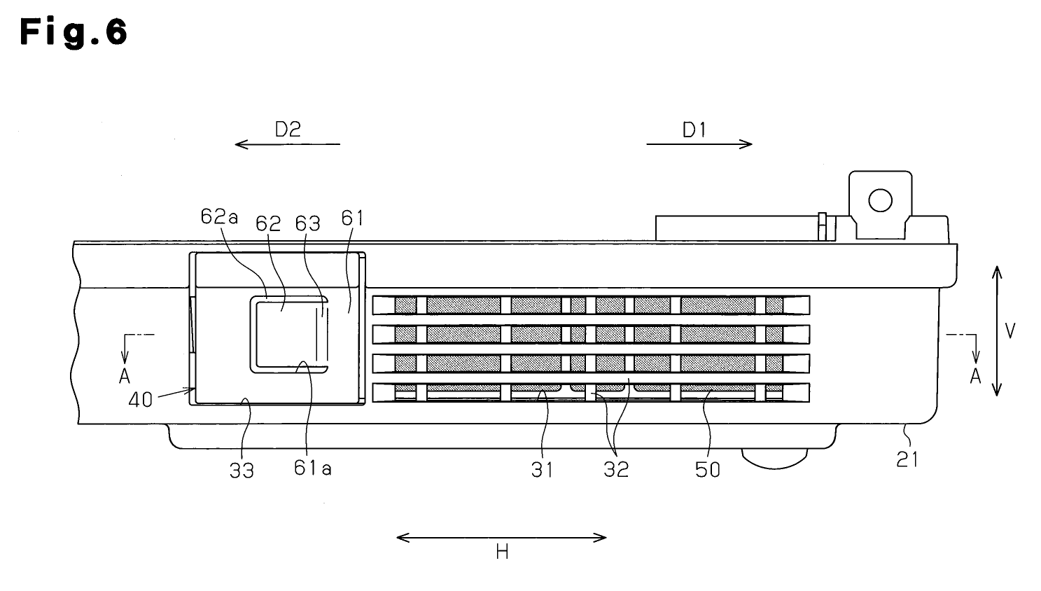

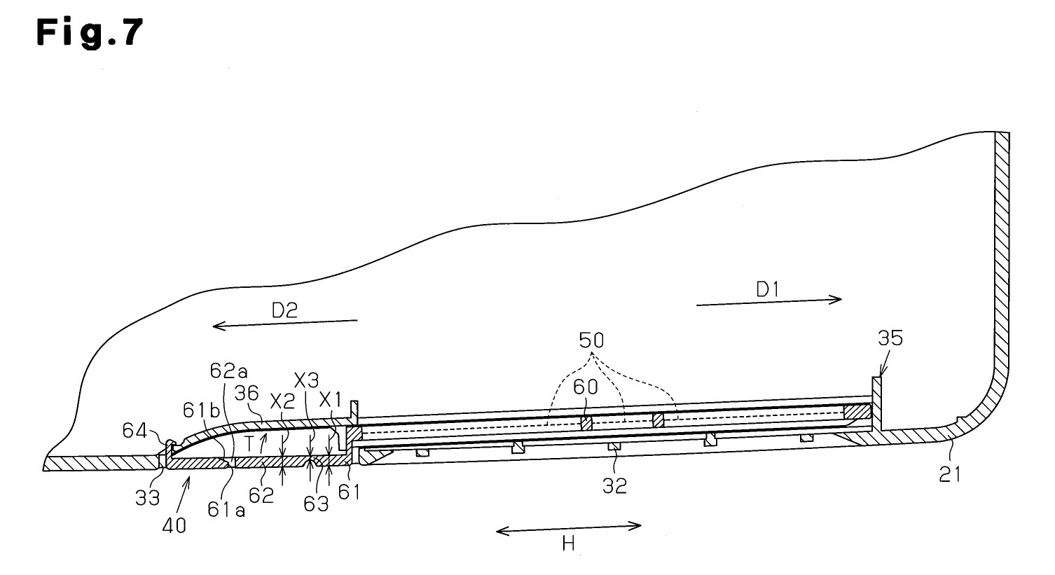

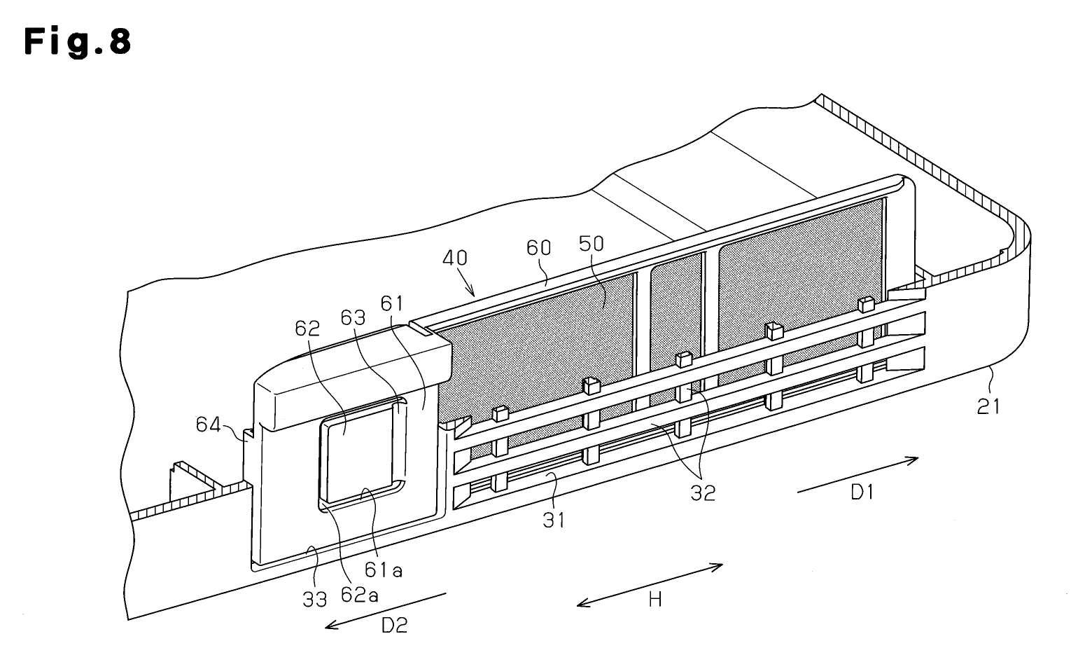

FIGS. 6 to 8 show the filter 40 in a state attached to the lower cabinet 21. FIG. 7 is a cross-sectional view taken along line A-A in FIG. 6, and FIG. 8 is a perspective view showing the cross-section taken along line A-A of FIG. 6. In FIG. 8, only the lower cabinet 21 is shown in cross-section.

In the present embodiment, the filter 40 includes a finger insert portion 61 and a lid portion 62. The finger insert portion 61 extends from the support frame portion 60. The lid portion 62 is connected to the finger insert portion 61.

The structure of the filter 40 according to the present invention will now be discussed in detail.

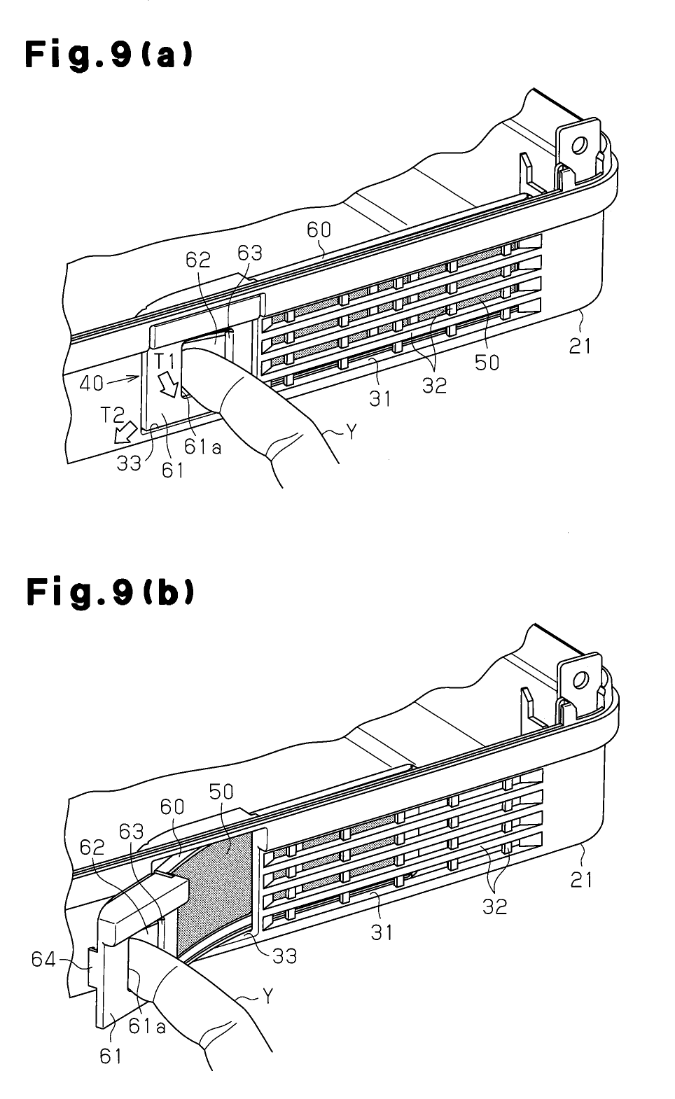

The finger insert portion 61, which is part of the support frame portion 60, is formed integrally with the support frame portion 60 and extends from the support frame portion 60 in the horizontal direction H as indicated by the arrow D2. The finger insert portion 61, which is formed integrally with the support frame portion 60, includes an insertion opening 61a, into which a finger Y (refer to FIG. 9) is insertable. In a non-restrictive example, the insertion opening 61a is, for example, tetragonal.

The lid portion 62 has a contour that is smaller than the contour of the insertion opening 61a. The lid portion 62 is connected to the finger insert portion 61 by a connecting portion 63. In the present embodiment, the support frame portion 60, the finger insert portion 61, the lid portion 62, and the connecting portion 63 are formed integrally. Further, the connecting portion 63 and the lid portion 62 extend inward from the wall defining the insertion opening 61a.

The lid portion 62 and the connecting portion 63 are thin, and the portion connecting the finger insert portion 61 and the lid portion 62 is small. This allows the lid portion 62, which covers the insertion opening 61a, to be resiliently bent with respect to the finger insert portion 61.

Specifically, as shown by the arrow T in FIG. 7, the lid portion 62 is resiliently bendable toward the interior of the lower cabinet 21, that is, the interior of the housing 20. The insertion opening 61a opens (becomes exposed) when the lid portion 62 is resiliently bent with respect to the finger insert portion 61. The insertion opening 61a is substantially closed when the lid portion 62 is at its original position.

In the present embodiment, the thickness X3 of the connecting portion 63 is smaller than the thickness X1 of the finger insert portion 61 and the thickness X2 of the lid portion 62, as shown in FIG. 7. Further, as shown in FIG. 8, a slit 62a is formed between the finger insert portion 61 and the lid portion 62. The slit 62a may be formed to have any shape that is in conformance with the contour of the lid portion 62, that is, the shape of the wall defining the insertion opening 61a. In the illustrated example, the slit 62a is a bent slit extending along three continuous sides of a tetragon. In further examples, the slit 62a may be a curved slit that extends along most of the contour of a circular shape or a slit that extends along a combination of straight lines and curves.

In the filter 40, the lid portion 62 is resiliently bent to open the insertion opening 61a for insertion of the finger Y. The finger Y is inserted into the finger insert portion 61 to pull out the filter 40 and detach the filter 40 from the housing 20.

Specifically, when detaching the filter 40 from the housing 20, as shown in FIG. 9(a), the lid portion 62 is pushed into the housing 20 with the finger Y. This resiliently bends the lid portion 62 with respect to the finger insert portion 61 as the finger Y is inserted into the insertion opening 61a. The finger Y, which is inserted into the insertion opening 61a, is then hooked onto a rear surface 61b of the finger insert portion 61 (refer to FIGS. 5 and 7). Then, the finger insert portion 61 is pulled outward from the housing in the direction of the arrow T1 in FIG. 9(a) to elastically bend the filter 40. In a state in which the filter 40 is elastically bent, the filter 40 is pulled in the direction of the arrow T2 in FIG. 9(a). This pulls the filter 40 out of the lower cabinet 21, as shown in FIG. 9(b). In this manner, the filter 40 is detached from the lower cabinet 21 and removed from the housing 20.

In the present embodiment, when the filter 40 is attached to the housing 20 and viewed from outside the housing 20 of the projector 10, the outer surface of the finger insert portion 61 is flush with the outer surface of the lid portion 62.

Further, when the filter 40 is attached to the housing 20 and viewed from outside the housing 20 of the projector 10, the outer surface of the finger insert portion 61 and the outer surface of the lid portion 62 are flush with the outer surface of the lower cabinet 21.

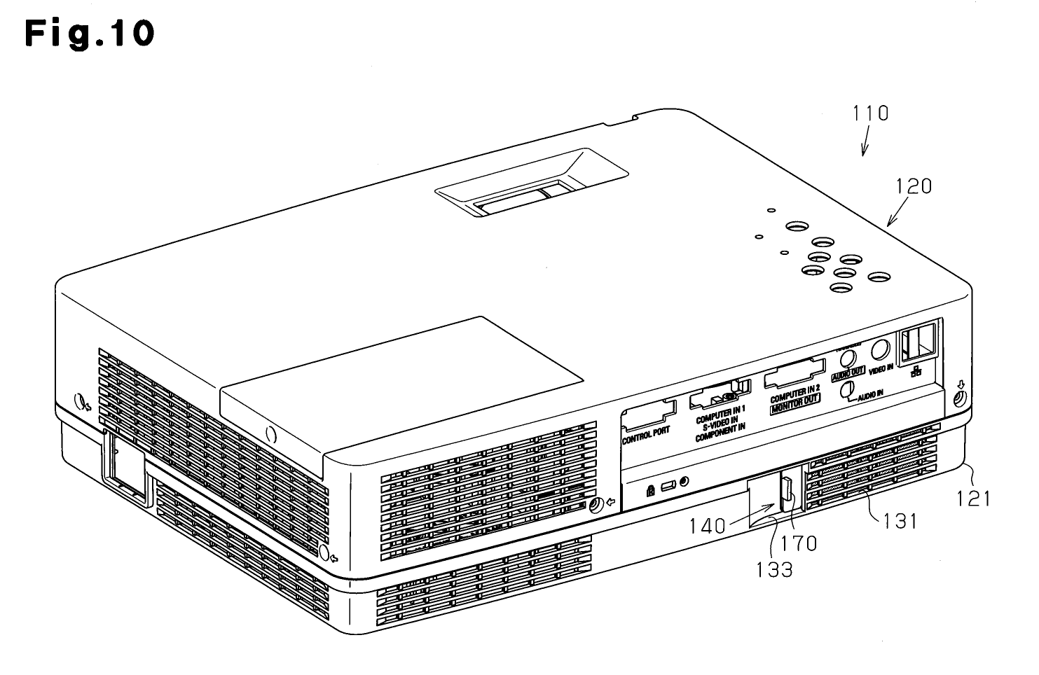

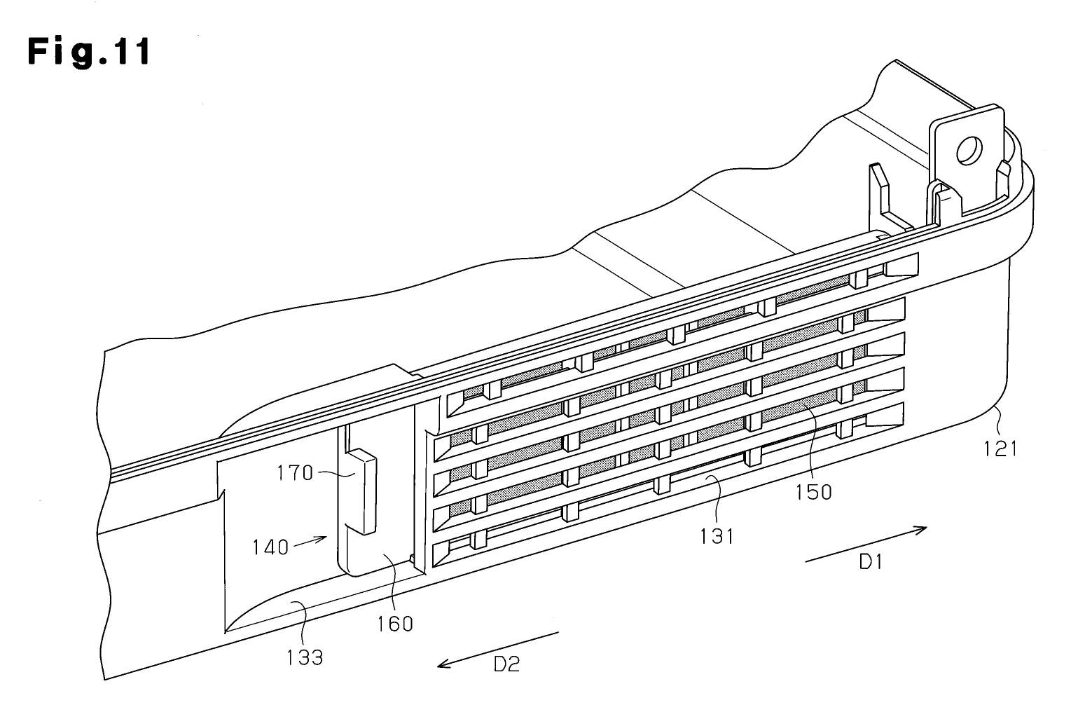

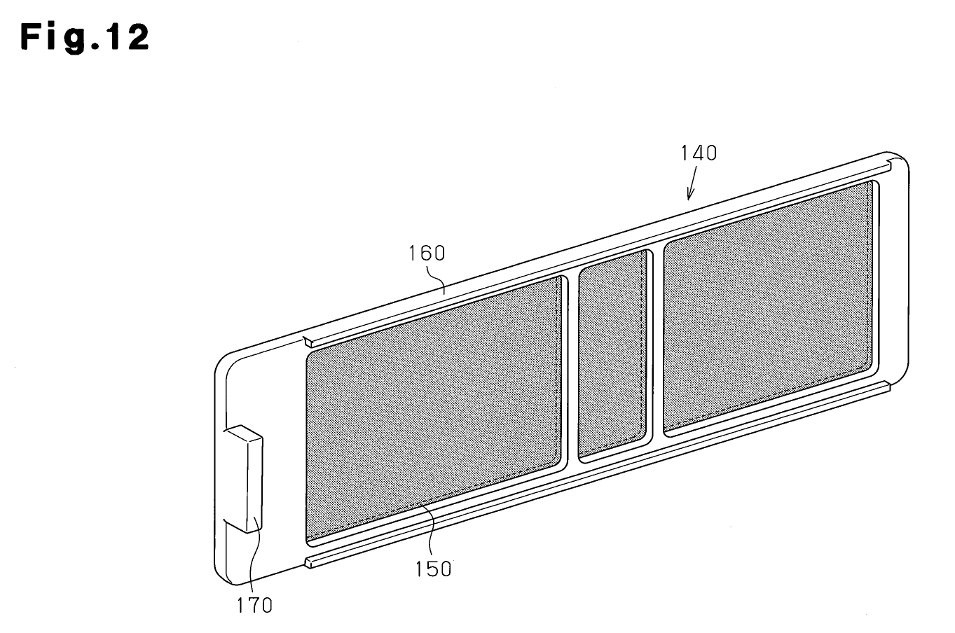

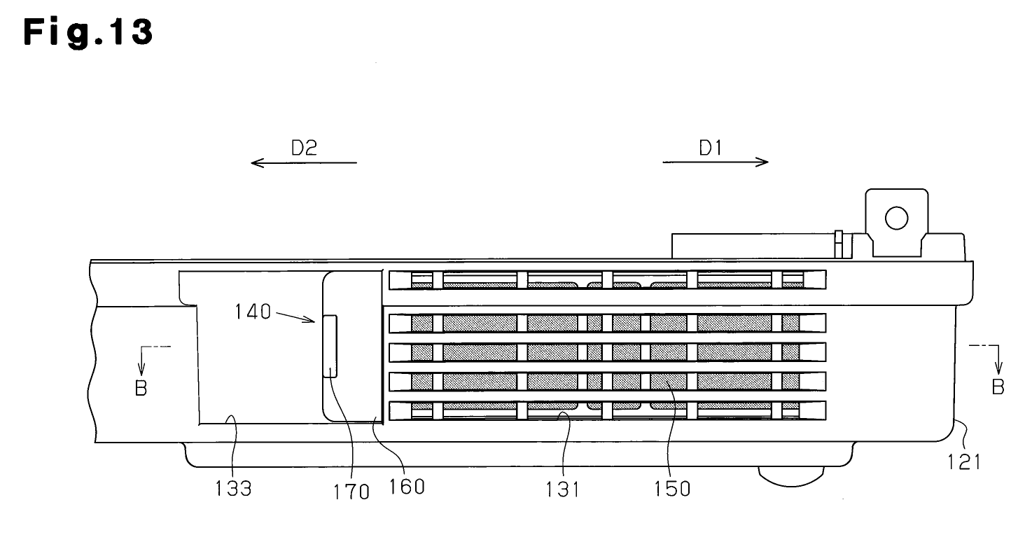

This structure improves the aesthetic appeal of the projector 10 as compared with the projector 110 shown in FIG. 10. More specifically, the projector 110 shown in FIG. 10 includes the tab 170 formed on the filter 140. Thus, when the projector 110 is viewed from outside the housing 120, the tab 170 creates ridges and valleys and thereby lowers the aesthetic appeal of the projector 110. In contrast, the structure of the present embodiment improves the aesthetic appeal of the projector 10.

The projector 10 includes a projection lens, which serves as an optical component. The projection lens emits light out of the housing 20 in the frontward direction. The filter 40 is arranged facing the rearward direction R of the housing 20. This improves the aesthetic appeal of the projector 10.

In the present embodiment, the finger insert portion 61 and the lid portion 62 cover the filter insertion receptacle 33, from which the filter 40 is inserted for attachment to the housing 20.

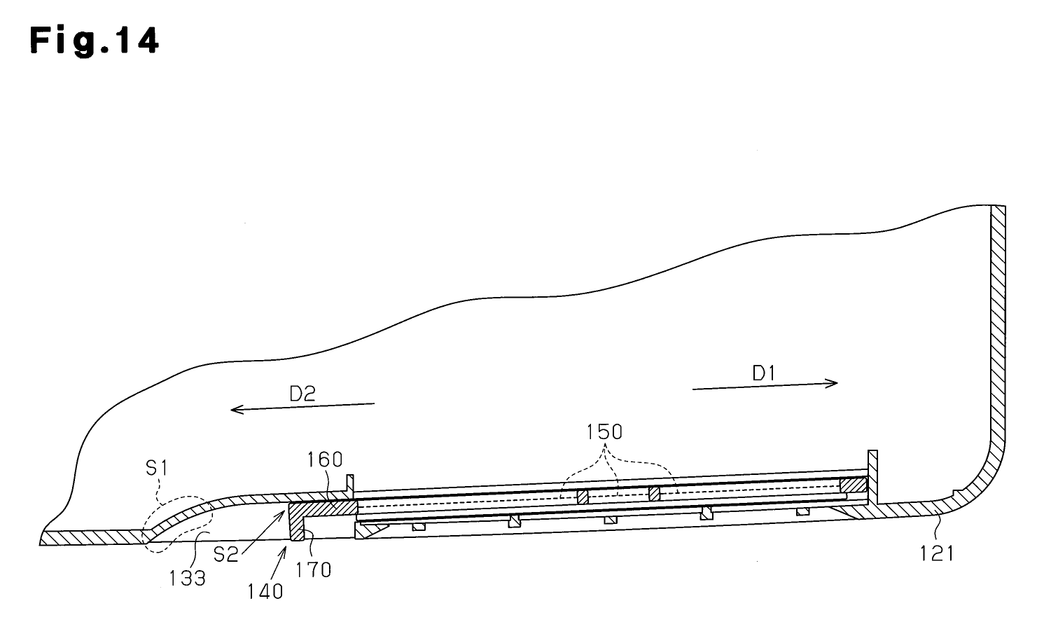

This structure improves the aesthetic appeal of the projector 10 as compared with the projector 110 shown in FIG. 10, while preventing dust from entering the projector 10. More specifically, the projector 110 shown in FIG. 10 requires space for the filter insertion receptacle 133 to allow for movement of the filter 140. Thus, when the projector 110 is viewed from outside the housing 120, the filter insertion receptacle 133 creates ridges and valleys and thereby lowers the aesthetic appeal of the projector 110. Further, in the projector 110 shown in FIG. 10, the filter insertion receptacle 133 is not covered by the filter 140 when the filter 140 is attached to the housing 120. Thus, dust may enter the projector 110 from the area at which the arrow S2 is marked in FIG. 14. In contrast, the structure of the present embodiment improves the aesthetic appeal, while preventing dust from entering the projector 10.

Further, in the present embodiment, a wall 36 is formed in the lower cabinet 21 to prevent foreign matter such as dust from entering the projector 10 through the filter insertion receptacle 33. The wall 36 forms part of the lower cabinet 21 and serves as the recess extending into the housing 20 that defines the filter insertion receptacle 33. In comparison to when there is no wall 36, the wall 36 prevents dust from entering the projector 10.

A hook 64, which is engageable with the wall 36, is formed on the distal end of the finger insert portion 61. In the present embodiment, the hook 64 includes a catch. The hook 64 is engaged with the wall 36 to hook the filter 40 to the lower cabinet 21.

The finger insert portion 61 may be referred to as a finger reception portion. The lid portion 62 may be referred to as an inner lid plate portion of the finger reception portion. In the finger reception portion, the portion at the outer side of the lid portion 62 may be referred to as an outer ring. The connecting portion 63 may be referred to as a resilient hinge. The insertion opening 61a may be referred to as a finger insertion opening. The structure of the finger insert portion 61 may be restated in the following manner. In the finger reception portion (61), the formation of the slit 62a partitions the inner lid plate portion (62), the resilient hinge (63), and an outer ring, which is arranged at the outer side of the inner lid plate portion across the slit 62a. When a pressing force is applied to the inner lid plate portion (62), the inner lid plate portion (62) is resiliently pivoted about the resilient hinge (63) to an open position (FIGS. 9(a), (b)). The movement of the inner lid plate portion (62) expands the slit (62a) and exposes the finger insertion opening (61a). When the pressing force is released from the inner lid plate portion (62), the inner lid plate portion (62) resiliently returns to its original position (FIG. 4) as it pivots about the resilient hinge (63). This closes the finger insertion opening (61a). The support frame portion and the finger reception portion may be an integrally formed product of synthetic resin.

The present embodiment has the advantages described below.

(1) The filter 40 includes the finger insert portion 61 and the lid portion 62. The finger insert portion 61 extends from the support frame portion 60 and includes the insertion opening 61a into which the finger Y is insertable. The lid portion 62 is connected to the finger insert portion 61 so as to cover the insertion opening 61a and resiliently bends with respect to the finger insert portion 61 so as to open the insertion opening 61a. Thus, by inserting a finger into the open insertion opening 61a, the finger engages the filter 40. This moves the filter 40 more easily than when holding a tab with one's fingertips to move the filter 40. Accordingly, the filter 40 is easily detached from the housing 20 of the projector 10. Further, the lid portion 62 covers the insertion opening 61a. Thus, the insertion opening 61a prevents foreign matter such as dust from entering the projector 10 through the insertion opening 61a, while allowing for insertion of the finger Y.

(2) The filter 40 includes the connecting portion 63, which is formed integrally with the finger insert portion 61 and the lid portion 62. The connecting portion 63 connects the finger insert portion 61 and the lid portion 62. The connecting portion 63 is thinner than the finger insert portion 61 and the lid portion 62. Thus, the lid portion 62 easily resiliently bends with respect to the finger insert portion 61, and a finger may be easily inserted into the insertion opening 61a.

(3) The support frame portion 60, the finger insert portion 61, and the lid portion 62 are formed integrally. Thus, the finger insert portion 61 and the lid portion 62 do not need to be formed by components that differ from the support frame portion 60.

(4) When the filter 40 is attached to the housing 20 of the projector 10 and viewed from outside the housing 20, the outer surface of the finger insert portion 61 is flush with the outer surface of the lid portion 62. Thus, the finger insert portion 61, which includes the insertion opening 61a, is not noticeable. This improves the aesthetic appeal of the projector 10 that includes the filter 40.

(5) The projector 10 includes the housing 20, which accommodates optical components for projecting and displaying graphical images, and the filter 40. Thus, the filter 40 is easily detachable from the housing 20 of the projector 10 as described in advantages (1) to (4). In particular, the housing 20 of the projector 10 accommodates optical components for projecting and displaying graphical images and dust and the like must be prevented from entering the projector 10. The filter 40, which is arranged in the air inlet 31 of projector 10, prevents foreign matter such as dust from entering the electrical device from the insertion opening 61a, while enabling insertion of the finger Y into the insertion opening 61a.

(6) When the filter 40 is attached to the housing 20 of the projector 10 and viewed from outside the housing 20, the outer surface of the lower cabinet 21 is flush with the outer surface of the finger insert portion 61 and the outer surface of the lid portion 62. Accordingly, the filter 40 does not project out of the projector 10. This improves the aesthetic appeal of the projector 10.

(7) The projector 10 includes the projection lens and the filter 40. The projection lens functions as an optical element and emits light out of the housing 20 in the frontward direction F from the front of the housing 20. The filter 40 is arranged on the rear of the housing 20 facing the rearward direction R. Thus, the filter 40 is less noticeable than when the filter 40 is arranged on the housing 20 facing the frontward direction F or the sideward direction S. Accordingly, the aesthetic appeal of the projector 10 is further improved.

(8) When the filter 40 is attached to the housing 20, the finger insert portion 61 and the lid portion 62 cover the filter insertion receptacle 33. Thus, the filter insertion receptacle 33 is not noticeable. This further improves the aesthetic appeal of the projector 10.

(9) The lower cabinet 21 includes the wall 36 that covers the filter insertion receptacle 33. Further, the finger insert portion 61 includes the hook 64 that is engageable with the wall 36. Thus, the filter 40 is hooked to the housing 20 when the hook 64 of the finger insert portion 61 is engaged with the wall 36 of the lower cabinet 21. Accordingly, the filter 40 when attached to the housing 20 is prevented from accidentally falling out of the housing 20.

It should be apparent to those skilled in the art that the present invention may be embodied in many other specific forms without departing from the spirit or scope of the invention. Particularly, it should be understood that the present invention may be embodied in the following forms.

The shapes of the finger insert portion 61 and the lid portion 62 may be varied as required. Further, as long as the lid portion 62 may be resiliently bent to open the insertion opening 61a, the thicknesses of the lid portion 62 and connecting portion 63 and the area of the connecting portion 63 may be varied as required.

The present examples and embodiments are to be considered as illustrative and not restrictive, and the invention is not to be limited to the details given herein, but may be modified within the scope and equivalence of the appended claims.

What is claimed is:

1. A slide-type filter for detachably attaching to a housing of an electrical device, the filter comprising:
a support frame portion that supports a filter element;
a finger insert portion extending from the support frame portion and including an insertion opening into which a finger is insertable; and
a lid portion connected to the finger insert portion so as to cover the insertion opening, wherein the lid portion resiliently bends with respect to the finger insert portion to open the insertion opening.

2. The filter according to claim 1, further comprising:
a connecting portion that connects the finger insert portion and the lid portion and is formed integrally with the finger insert portion and the lid portion, the connecting portion having a thickness that is less than that of the finger insert portion and the lid portion.

3. The filter according to claim 1, wherein the support frame portion, the finger insert portion, and the lid portion are formed integrally.

4. The filter according to claim 1, wherein when the filter is attached to the housing of the electrical device and viewed from outside the housing, the finger insert portion is flush with the lid portion.

5. A video projector comprising:
a housing that accommodates an optical component for projecting and displaying a graphical image; and
the filter according to claim 1 attached to the housing.

6. The video projector according to claim 5, wherein when the filter is attached to the housing and viewed from outside the housing, the finger insert portion and the lid portion are flush with the housing.

7. The video projector according to claim 5, wherein the optical component includes a projection lens that emits light out of the housing from the front of the housing; and
the filter is arranged at the rear of the housing.

8. The video projector according to claim 5, wherein part of the housing forms a filter insertion receptacle into which the filter is inserted, with the filter insertion receptacle being covered by the finger insert portion and the lid portion when the filter is attached to the housing.

9. The video projector according to claim 8, wherein part of the housing forms a wall covering the filter insertion receptacle from inside the housing; and
the finger insert portion includes a hook that is engageable with the wall.

10. A slide-type air filter for detachably attaching to a ventilation hole of a video projector housing, the air filter comprising:
a film-like filter element having a rim;
a support frame portion that supports at least the rim of the filter element; and
a finger reception portion formed integrally with the support frame portion, the finger reception portion including:
an inner lid plate portion partitioned by a slit;
an outer ring arranged at an outer side of the inner lid plate portion across the slit; and
a resilient hinge that connects the inner lid plate portion and the outer ring so that the inner lid plate portion is resiliently movable relative to the outer ring; wherein the inner lid plate portion resiliently pivots to an open position about the resilient hinge when a pressing force is applied to the inner lid plate portion, and the pivotal movement of the inner lid plate portion expands the slit and exposes a finger insertion opening; and wherein the inner lid plate portion resiliently pivots about the resilient hinge and returns to its original position when the pressing force applied to the inner lid plate portion is released thereby closing the finger insertion opening.

11. The air filter according to claim 10, wherein the support frame portion and the finger reception portion are an integrally formed product of synthetic resin.

12. A video projector, comprising:
the air filter according to claim 10; and
a housing provided with a filter insertion receptacle that receives the support frame portion and the filter element of the air filter, wherein the housing is flush with the inner lid plate portion, the outer ring, and the resilient hinge of the air filter.
